(19) United States
(12) Patent Application Publication
(10) Pub. No.: US 2008/0001438 A1
(43) Pub. Date: Jan. 3, 2008

(54) Hardtop superstructure for a body of motor vehicle

(76) Inventor: Berthold Zentgraf, Kuenzell (DE)

Correspondence Address: RATNERPRESTIA, P O BOX 980, VALLEY FORGE, PA, 19482-0980, US

(21) Appl. No.: 11/648,229

(22) Filed: Dec. 29, 2006

(30) Foreign Application Priority Data
Jun. 30, 2006 (DE) 20 2006 010 160.8

(51) Int. Cl. B60J 7/047

(52) U.S. Cl. 296/210

(57) ABSTRACT

A superstructure configured to be assembled on a body of a motor vehicle which comprises a rollover-proof passenger compartment which is open upwards, the superstructure forming a solid roof extending beyond the passenger compartment as far as a rear end of the body. A vehicle body assembly, a superstructure system and a production assembly incorporating such a superstructure are also provided.

This application claims priority to German Utility Registration. No. 20 2006 010 160.8 filed Jun. 30, 2006, which is incorporated in its entirety by reference herein.

### BACKGROUND OF THE INVENTION

1. Technical Field

The invention relates to a superstructure for a body of a motor vehicle, to the body comprising the assembled superstructure, and to a set of superstructures of different types, adapted to the body, wherein a convertible or a station wagon can be produced by selectively assembling said superstructures on the body. The invention further relates to a production plant for variably fitting the bodies with the superstructures, which are different in terms of type, from the set of superstructures.

2. Description of the Related Art

The increasing variety in types of motor vehicles makes economic series production more difficult. Manufacturers compensate for segmentation for example by using the same platforms for different vehicle models. DE 198 33 395 C2 goes even further, in proposing that different superstructures, front parts and rear end modules can be combined with passenger compartments which are always the same. The superstructures comprise respectively bearing pillar portions of the body which are placed on bearing pillars of the passenger compartment and permanently connected, for example welded, to the bearing pillars. This concept enables a large variety of types to be produced on the basis of a unified passenger compartment, but requires major adaptations and therefore an extensive readjustment of current productions.

DE 197 29 044 A1 discloses a proposal which aims to broaden the possible uses of a motor vehicle and can be comparatively simply implemented, in particular even subsequently by the owner of the vehicle. In accordance with this proposal, a roof opening provided, for example of a sunroof, is used to fasten a roof covering which is available as a retrofitting set and comprises an integrated bearer for luggage, bicycles, skis, surfboards or other equipment. The possibility of using an ordinary motor vehicle as a motor home by means of the roof covering is also cited.

### SUMMARY OF THE INVENTION

It is an object of the invention to increase the variability of motor vehicles, wherein the increase should not require or require only a slight readjustment of the production.

The invention has identified convertibles as a variable type of motor vehicle which can be retrofitted into a station wagon comprising a hardtop extending as far as the rear end at comparatively little cost or can be produced as a convertible or station wagon from the outset by the manufacturers. The starting point is a body of a convertible or of the type of a convertible body—also called a base body in the following—comprising a passenger compartment which is open upwards and protects the occupant or occupants in the event of the vehicle overturning. The passenger compartment exhibits the strength and shape necessary for such protection and is in this sense rollover-proof. A straight line, which connects the upper end of an A-pillar or of a crossbeam running over the windscreen to the upper end of the next supporting element in the direction of the rear end, runs over the driver's head. The supporting element can for example be another pillar, a crossbeam which spans the passenger compartment, a safety bar provided separately for the driver or another passenger or for example a portion of the body located behind the passenger compartment, if such a portion is high enough for the projected line to run over the driver's head and as applicable the heads of other passengers. The supporting element exhibits a strength which is sufficient to protect the passengers in the event of rolling over. The body can for example be that of a sedan, with four or five full seats, that of a roadster or in particular that of a classically sporty convertible with two seats only or two full seats and two auxiliary seats. The body can correspond to that of a convertible with a steeply sloping rear end, however the potential of the invention is in particular manifest in convertible bodies comprising a notchback.

The invention provides a superstructure which can be assembled on the body instead of a convertible roof or in addition to a retracted convertible roof and which forms a solid roof which extends as far as the rear end of the vehicle. A sunroof, a hinged roof, a transparent area or a combination of such components can be integrated in the roof of the superstructure. The superstructure only slopes steeply in the region of the rear end, such that storage space behind the passenger compartment is gained, such as is offered by a station wagon. The gain in space is above all considerable in cases where the body forms a notchback.

The superstructure as a whole can be formed as a dimensionally stable shell structure made of plastic, in particular fiber composite plastic, for example carbon fiber reinforced plastic, sheet metal or another shell material. It preferably includes a shell structure such as forms the predominant part of the overall area of the superstructure. The shell structure is preferably sufficiently dimensionally stable that it can be placed onto the body and is borne without additional support, under normal driving conditions. The shell structure can be formed in one piece. A front end portion, which forms a front end of the superstructure and covers a front region of the passenger compartment following and connected to the front end and extends as far as the lateral left-hand and right-hand edge of the superstructure, is formed like conventional hardtops for convertibles, though of course adapted to the respective base body. The front end portion of the superstructure transitions into a rear end portion which continues the roof area of the front end portion in the direction of the rear end and at its end slopes steeply towards the rear end of the vehicle in a rear end area, such that storage height is gained in the region of the trunk. An inclination of 45° to the vertical is still regarded as steep. In the rear end portion, a left-hand and right-hand side area project downwards from the roof and transition into the rear end area of the superstructure at the rear end. The side areas continue the passenger compartment, in order to integrate a trunk, formed in the region of the rear end of the body, into the passenger compartment in the manner of a station wagon, or to at least span it and enlarge it upwards. The shell structure can comprise one or more apertures or cavities comprising inserts or attachments, for example a rear end or side window or a hatchback, in addition to or instead of those already cited. A window can be formed from plastic, and integrally with the shell, for example by multi-component injection molding. More preferably, it is inserted and fastened to the shell structure. Side windows can each be accommodated and completely framed or formed on or placed on in an aperture or inserted into a cavity and fastened, such that they form an edge portion of the superstructure. The window or windows need not be transparent, although this is preferred, at least for a rear end window. Thus, areas can be provided in the side areas of the rear end portion which continue the side windows mounted by the body towards the rear and are adapted to them in terms of shape and preferably also color, such that they imitate the side windows but are themselves non-transparent or opaque. More preferably, however, the relevant areas are substantially as transparent as side windows mounted by the body. A hinged loading window is advantageously arranged in the region of the rear end, either in a non-moving or preferably in a moving rear area of the superstructure.

The front end of the superstructure and the two sides of the superstructure following and connected to the front end advantageously comprise an edge for forming a universally waterproof joint along the edge with an upper edge of the passenger compartment. The superstructure forms said joint edge in a way known from convertible roofs and hardtops which can be exchanged for them. In the rear region of the superstructure, a rear joint edge follows and is connected to said front joint edge and—unlike previously conventional hardtops—serves to form a waterproof joint at the rear end of the base body and at the rear side regions following and connected to the rear end. In preferred embodiments, the joint edge extends circumferentially and continuously along the front end, the sides and the rear end of the superstructure, in order to obtain a correspondingly circumferentially waterproof joint with the body, which is universally based only on a pressing contact between the joint edges forming the joint. A sealing material is advantageously applied or arranged along the joint edge of the superstructure, at least in the front side region, in order to form a waterproof joint with the side windows mounted by the base body. Sealing material is preferably arranged or applied along the entire joint edge of the superstructure. Sealing material is preferably likewise arranged or applied along the joint edge of the base body, however it would in principle be sufficient to provide only one of the two joint edges with sealing material. The sealing material is preferably formed by one circumferential sealing element or by multiple inserted or attached sealing elements.

A circumferential joint based only on a force fit is in particular advantageous when the hardtop superstructure in accordance with the invention serves to retrofit a convertible. For retrofitting a convertible comprising a notchback, the roof and trunk lid are disassembled and the superstructure is assembled instead. Such an exchange is primarily applicable when the base body and the convertible roof exhibit a construction which is inherently provided for retrofitting or can for other reasons be disassembled simply. The superstructure can also be provided for assembly on a retracted convertible roof, primarily space-saving retracted convertible roofs, in particular folding roofs which are retracted by hand and therefore take up less space when retracted than roofs which can be automatically extended and retracted.

For the purposes of retrofitting a convertible, the superstructure can be sold as such, either separately for subsequent retrofitting or together with the convertible as an auxiliary. The subject of the invention also includes the combination of a base body and assembled superstructure, irrespective of whether the combination has been supplied ex works or only subsequently created by retrofitting. The body comprising the superstructure can be part of a finished vehicle or can be provided as such for further processing.

The invention further relates to a set of superstructures which can selectively be assembled on the same body. The set of superstructures includes a convertible roof and the superstructure in accordance with the invention. The convertible roof can in particular be a folding roof or hinged roof, though in principle any mechanism is applicable by means of which the convertible roof can be extended to span the passenger compartment and retracted to expose the entire overhead region of the passenger compartment. The invention relates to convertible roofs which can be automatically extended and retracted and also to those which are manually extended and retracted.

In preferred embodiments, the joint edge of the superstructure is contoured over a major part of its edge profile to match the joint edge of the convertible roof of the same set of superstructures, such that the body forms the same joint with said part of the joint edge as with the convertible roof. The joint edge of the superstructure is advantageously contoured to match the profile of the joint edge formed by the body for a trunk lid, at least at the rear end, but preferably also on the sides, such that for the waterproof force fit in the region of the trunk, the joint edge of the body provided there can be used both for the trunk lid of the convertible version and the superstructure of the station wagon version.

A preferred embodiment of the base body, which the subject of the invention includes as such, comprises connecting means both for the convertible roof and the superstructure in accordance with the invention. The connecting means can be simple fastening points, for example stationary pins, bolts, in particular screw bolts, or nuts, or can be more complex connecting means, for example a lock or a bolt for a lock-and-bolt connection with the superstructure. Preferably, both types of superstructure use at least one of the connecting means together. Such a connecting means can for example be arranged on a crossbeam connecting the left-hand A-pillar to the right-hand A-pillar or in its vicinity in the front region of the passenger compartment, above the passengers. The connecting means can in particular be manually and automatically operable, as known from sunroofs or folding or hinged roofs, in order to be able to quickly release the connection with the respective superstructure, for example the convertible roof. A trunk lock is likewise a preferred example of a connecting means both for one type and the other type of superstructure. When the convertible roof is assembled, the lock locks together with a trunk lid which preferably forms part of said superstructure, while for the superstructure in accordance with the invention, it can form a fastening point on the body. If the superstructure in accordance with the invention is fitted with a hatchback, as is preferred, the lock on the body for the hatchback can fulfill the same function as for the trunk lid of the convertible version. The respective lock can be arranged on the superstructure instead of on the body. If the base body is completely standardized with regard to the connecting means, at least one of the connecting means cooperates only with one type of superstructure and at least another of the connecting means cooperates only with the other type of superstructure. In such embodiments, the body in the convertible version comprises the at least one unused connecting means in the region of the trunk, while in the station wagon version and disassembled convertible roof, the fastening points are not used or only some of them are used to fasten the superstructure in accordance with the invention. In many cases, joint elements for a trunk lid are likewise unused once disassembled.

As already mentioned, the superstructure and set of superstructures can serve to retrofit a convertible which the user can then convert into a station wagon, for example for winter.

The invention is not, however, limited to retrofitting but also helps to reduce the cost of convertible bodies in series production. Convertibles are produced in comparatively small numbers. On the one hand, greater numbers may be expected alone because of the increased utility due to the possibility of retrofitting, since new buyers can be gained. On the other hand, however, bodies for subsequent convertibles and bodies for subsequent station wagons can be produced on the same production line, since the two types of vehicle are only differentiated at a later point in time by assembling either the convertible roof or the hardtop superstructure of the set of superstructures in accordance with the invention. If the convertible is one comprising a notchback, the trunk lid is also assembled in addition to the convertible roof. The superstructures can be assembled at another location, separate from the production of the base body, even for example by a different company. As an alternative to complete decoupling, superstructures of one type can be assembled after the body production, still in the same production line, while the superstructures of the other type are assembled at another location, separate from the production line. Lastly, in another alternative, both types of superstructure can be assembled straight after the bodies and in their production line, either successively in series or adjacently in parallel. If assembled in parallel in the production line, a switch can be provided in their conveying line, in order to be able to ramify the stream of base bodies. As an alternative to a switch, some of the base bodies in the conveying line can be relayed to an assembly station for one of the two types of superstructure, while others are discharged from the conveying line and fed to an assembly station, arranged next to the conveying line, for the other type of superstructure.

In preferred productions, the superstructures are only assembled after one of the following productions steps: a) painting the bodies; b) assembling the dashboard and steering wheel; c) assembling the seats; or d) assembling the doors. Preferably, the superstructures are only assembled after at least two of the cited steps have been performed, even more preferably only after at least three of the cited steps have been performed. In production, these steps are conventionally performed in the following order: painting the vehicle body, and advantageously the already assembled doors, then disassembling the doors if they were for example assembled for painting, and assembling the dashboard and seats and then assembling the painted doors again and adjusting the doors. The superstructures can in principle be assembled before or between any two of these production steps, but are preferably only assembled in the final assembly and particularly preferably after all the cited steps have been performed.

Preferably, one of the two types of superstructure is assembled in the production line of the base bodies, i.e. in-line. Along the conveying line on which the working station or stations for joining the base body is/are arranged, a first assembly station is also arranged in which the superstructures of the relevant type are assembled onto the base bodies. Base bodies provided for assembling the other type of superstructure are preferably conveyed through the first assembly station without it acting on the bodies. The bodies with no superstructure can be provided with the relevant superstructures at another location, i.e. off-line. They can in particular be stored in an interim storage facility and transported in groups to the other assembly location, for example by rail. In an equally preferred alternative, a second assembly station for in-line assembly is arranged downstream of the first assembly station along the conveying line, in which the superstructures of the other type are assembled onto the base bodies conveyed through the first assembly station without being processed. A controller of the conveying line knows which bodies are to be fitted with which superstructure. The controller activates and deactivates the first assembly station, and also correspondingly the second assembly station if it likewise operates in-line. The trunk lids for convertibles comprising a notchback are assembled in the assembly station provided for assembling the convertible roofs or in another, dedicated assembly station assigned to the assembly station for the convertible roofs. The controller can assign it alone for any arrangement of said assembly station along the conveying line, by activating the station for assembling the lid and deactivating the station for conveying bodies for station wagons through. It is also preferably assigned spatially. If the convertible roofs are assembled in-line, the assembly station for the trunk lids is preferably arranged downstream of the assembly station for the convertible roofs. If the convertible roofs are assembled off-line, the trunk lids are preferably likewise assembled off-line when assembling the roof.

### BRIEF DESCRIPTION OF THE DRAWINGS

An exemplary embodiment of the invention is explained below on the basis of the figures. Features disclosed by the exemplary embodiment may be present in the invention individually or in any combination of features. In the figures, there is shown:

FIG. 1 is a perspective view of a convertible comprising a base body and a hinged roof, and

FIG. 2 is a perspective view of a station wagon comprising the base body of the convertible and a hardtop superstructure.

### DETAILED DESCRIPTION OF THE PREFERRED EMBODIMENTS

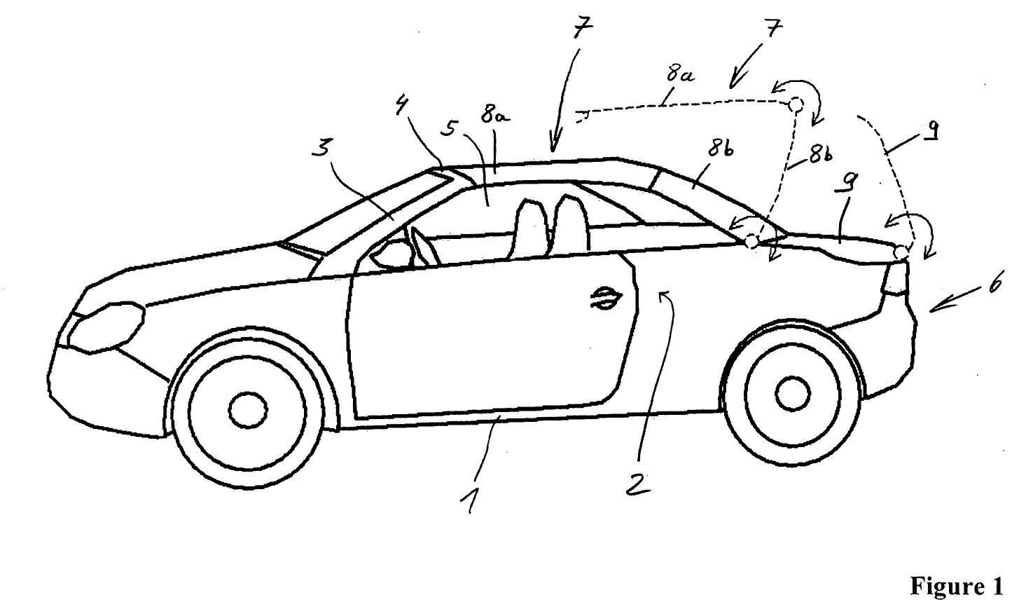

FIG. 1 shows a two-door convertible comprising a hinged roof 7 and a notchback. It comprises a body 1 including a floor, a front end part, two side parts and a rear end part. The body 1 forms a passenger compartment 2 for a maximum of four passengers. The passenger compartment 2 is rollover-proof, as is required for convertibles. This is ensured in the front region of the passenger compartment 2 by the two A-pillars 3 projecting over the passengers' heads, together with the crossbeam 4 connecting them, and in the rear region of the passenger compartment 2 by supporting elements arranged behind the rear seats or integrated into the back(s) of the rear seats, which likewise project over the passengers' heads. The body 1 otherwise reaches only to about the shoulder height of the seated passengers, where it forms a substantially horizontal line on each side, crossed only the side windows 5 when extended.

A trunk is formed behind the passenger compartment 2 in the region of the rear end of the vehicle and is closed by a trunk lid 9. The trunk lid 9 is hinged at a first transverse axis near the passenger compartment 2 for gaining access to the trunk, and at a second transverse axis formed at the rear end 6 of the vehicle for extending and retracting the hinged roof 7. The trunk lid 9 forms a waterproof joint, running laterally in the longitudinal direction of the vehicle, with each of the side parts of the body 1.

On each of its two sides, the hinged roof 7 comprises a side beam 8 consisting of two beam portions 8a and 8b which, when extended, extend along the upper edge of the side window 5 from the upper end of the A-pillar 3 to the trunk. In a jointed connection with the body 1, the rear beam portion 8b can fold into the trunk relative to the body 1 and fold out again into the position shown. In a jointed connection with the rear beam portion 8b, the front beam portion 8a can fold into the trunk relative to the rear beam portion 8b and relative to the body 1 and fold out again into the position shown. A sunroof is integrated and a rear end window incorporated in the hinged roof 7 between the side beams 8. For retracting the hinged roof 7, the trunk lid 9 folds opens at the second transverse axis formed at the rear end 6 and, once the roof has been retracted, folds closed again. The hinged roof 7 and the trunk lid 9 are also shown in a position while the hinged roof 7 is being retracted, each by a dotted line.

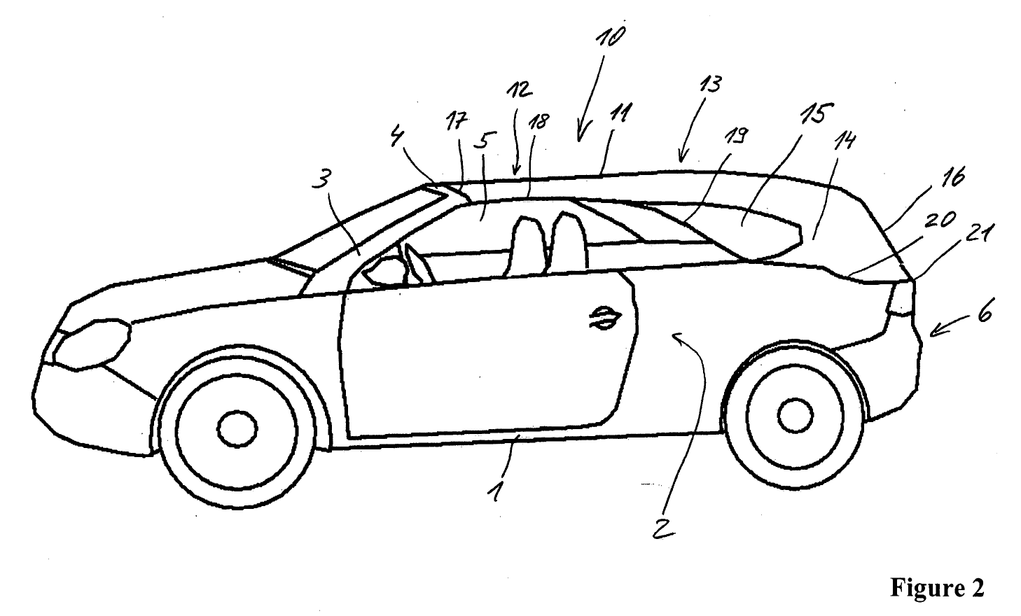

FIG. 2 shows a station wagon which is a station wagon version of the convertible. The body 1 of the station wagon corresponds to the body 1 of the convertible. Except for the hinged roof 7 and trunk lid 9, the station wagon also comprises all the attachments and inserts of the convertible, for example the same doors, the same side windows 5 and the same rear end lights. The hinged roof 7 and trunk lid 9 are replaced by a superstructure 10 formed as a station wagon hardtop. The superstructure 10 forms a roof 11 which extends from the crossbeam 4 over the entire passenger compartment 2 and also over the trunk and only slopes steeply towards the rear end part of the body 1 near the rear end 6. The superstructure 10 comprises a front end portion 12 which extends from the crossbeam 4 in the longitudinal direction of the vehicle above the side windows 5, and is formed like the hinged roof 7 of the convertible. The superstructure 10 also comprises the integrated sunroof. Following and connected to the front end portion 12, however, is a rear end portion 13 whose shape significantly deviates from the shape of the extended hinged roof 7. On the one hand, the superstructure 10 is substantially longer than the hinged roof 7. On the other hand, side areas 14 which in the rear end portion 13 extend over an area from the roof 11 project downwards as far as the region of the rear end of side parts of the body 1. The superstructure 10 thus forms a voluminous, closed upper region of the rear end of the vehicle which correspondingly provides additional storage space. The roof 11 transitions into a rear end area 16 which terminates the superstructure 10 at the rear end. The rear end area 16 extends, like the trunk lid 9 of the convertible, as far as the rear end part of the body 1, which projects a little way beyond a rear shock absorber of the body 1.

The rear end area 16 includes a hatchback which is hinged at a transverse axis near the roof 11 and locks together with the same lock as the trunk lid 9 of the convertible. The rear end of superstructure 10 correspondingly comprises a cavity which is open towards the rear end part of the body 1 and in which the hatchback is accommodated. Alternatively, a hatchback could also be completely framed by areas of the superstructure 10, i.e. in an aperture comprising an edge encircling the hatchback. A framed hatchback can advantageously be formed as a loading window.

A side window 15 is incorporated into each of the side areas 14 of the superstructure 10. The side windows 15 are fastened to be non-moving. Each of the side windows 15 is seated in a cavity of the side areas 14 which is open towards the front. The side areas 14 enclose the corresponding side window 15 on three sides; a front side of the side windows 15 remains free. The free front edge of the side windows 15 extends from the rear end of the front end portion 12 as far as the respective side part of the body 1. The side windows 15 continue the upper and lower edge of the side windows 5 continuously, such that a harmonious extension of the respective side window 5 to near the rear end of the superstructure 10 is obtained. The side windows 15 are in contact with the side windows 5 along their front edge and are contoured along their front edge to match the contour of the two side beams 8 of the hinged roof 7 in the corresponding region.

The superstructure 10 consists of a shell structure made of plastic, moving inserts—in the example embodiment, the sunroof and the hatchback—and non-moving inserts which in the example embodiment form the side windows. The inserts are likewise formed from plastic. The shell body can be formed in one piece. It forms a structure which is inherently dimensionally stable, i.e. it is sufficiently resistant to torsion, bending and buckling that it can simply be placed onto the body 1 and connected by connecting means of the body in its front end portion 12 and in the lower region of its rear end portion 13 and thus fastened to the body 1, and does not require any additional support, i.e. it bears itself, in particular the roof 11.

In the front end portion 12, the superstructure 10 is fastened to the crossbeam 4 like the hinged roof 7, for which the connecting means used for the hinged roof 7 is/are advantageously used. For fastening, the front end portion 12 is expediently fitted with the same manually or automatically operable engaging means as the hinged roof 7, such that the superstructure 10 can also be quickly released from the body in this region. In the region of the rear end of the body 1, however,—preferably screw connectors—are additionally provided for the superstructure 10, which are not used for the hinged roof 7. Connecting means for the hinged roof 7 can by contrast also be used for fastening the superstructure 10.

The superstructure 10 is preferably only connected to the body 1 in a positive or force fit. A material fit at particular points is not however to be completely ruled out from the outset.

The superstructure 10 forms a joint, encircling the passenger compartment 2 and the rear end 6 and waterproof over its entire profile, with the body 1 and the side windows 5. The joint consists of the following joint portions: the front end portion 12 is in a sealing, pressing contact along a frontal edge with the crossbeam 4, such that a joint portion 17 is obtained there. Following and connected to the frontal edge, the front end portion 12 is in waterproof pressing contact with each upper edge strip of the extended side windows 5 and forms a left-hand and right-hand joint portion 18 with the side portions 5. The left-hand and right-hand joint portion 18 follow and are connected to a left-hand and right-hand joint portion 19 formed by an edge strip along the front edge of the side windows 15 and the side window 5 of the respective side of the vehicle. The joint edge of the superstructure 10, which contacts the side windows 5, corresponds to the joint edge with which the hinged roof 7 contacts the side windows 5. The same applies to the frontal edge of the superstructure 10. Preferably, the lateral joint edges of the superstructure 10 respectively form a groove, such that the side windows 5 are enclosed by the relevant joint edges. The side areas 14 continue the side windows 15 continuously as far as the rear end 6 in a left-hand and right-hand joint portion 20 in sealing, pressing contact with the side parts of the body 1. A joint portion 21, formed at the rear end 6 between the rear end area 16, including the hatchback, and the rear end part of the body 1, closes the circumference of the joint. The rear end lights each form a corner region of the joint edge of the body 1. The joint portions 20 and 21 correspond to the joint portions which the trunk lid 9 of the convertible forms with the body 1 on the sides and at the rear end 6. In the joint portions 17, 20 and 21, the joint edges of both parties I and 10 to the pressing contact are edged with sealing material, preferably in the form of attached or inserted sealing elements. In the joint portions 18 and 19, only the superstructure 10 is expediently edged with sealing material, preferably in the form of attached or inserted sealing elements.

In the foregoing description, a preferred embodiment of the invention has been presented for the purpose of illustration and description. It is not intended to be exhaustive or to limit the invention to the precise form disclosed. Obvious modifications or variations are possible in light of the above teachings. The embodiment was chosen and described to provide the best illustration of the principals of the invention and its practical application, and to enable one of ordinary skill in the art to utilize the invention in various embodiments and with various modifications as are suited to the particular use contemplated. All such modifications and variations are within the scope of the invention as determined by the appended claims when interpreted in accordance with the breadth they are fairly, legally, and equitably entitled.

What is claimed is:

1. A superstructure configured to be assembled on a body of a motor vehicle comprising a rollover-proof passenger compartment which is open upwards, said superstructure forming a solid roof, extending beyond the passenger compartment as far as a rear end of the body.

2. The superstructure according to claim 1, wherein the superstructure includes a front edge in a front end portion and lateral edge portions following and connected to the front end for forming a joint with the passenger compartment which is waterproof.

3. The superstructure according to claim 2, wherein opposed side windows are arranged in opposed sides of a rear end portion of the superstructure.

4. The superstructure according to claim 3, wherein the side windows are fastened in a material fit in a rear end portion of the superstructure.

5. The superstructure according to claim 1, wherein the superstructure further comprises at least one engaging means for a releasable fastening engagement with the body.

6. The superstructure according to claim 1, wherein a rear end portion of the superstructure comprises side areas which project downwards from the roof and are configured to be fastened to the body and a rear end area which projects downwards from the roof.

7. The superstructure according to claim 1, wherein the superstructure has a rear end area including a hatchback.

8. The superstructure according to claim 7, wherein the hatchback is provided with a rear end window.

9. The superstructure according to claim 1, wherein the superstructure comprises a shell structure made of plastic or sheet metal.

10. A motor vehicle assembly comprising: a motor vehicle base body which forms a rollover-proof passenger compartment which is open upwards; and a superstructure forming a solid roof configured, the superstructure connected to the base body and extending beyond the passenger compartment as far as a rear end of the base body.

11. The assembly according to claim 10, wherein the superstructure is connected to the base body in a region of the front end of the passenger compartment in the manner of a convertible roof which can be automatically or manually extended and retracted.

12. The assembly according to claim 11, wherein the superstructure is connected releasably to the base body.

13. The assembly according to claim 10, wherein the base body comprises at least one connecting element and the superstructure comprises at least one engaging element configured for a releasable fastening engagement with the connecting element.

14. The assembly according to claim 10, wherein the base body and the superstructure are in pressing contact with each other along a waterproof joint.

15. The assembly according to claim 10, wherein a front end portion of the superstructure is contoured, along a front edge and at lateral edge portions following and connected to the front edge, to match a contour of a convertible roof which is automatically or manually extended and retracted relative to the base body, and forms a waterproof joint with the base body.

16. The assembly according to claim 10, wherein a rear end portion of the superstructure comprises a side window which extends a side window of the base body towards the rear and is conformed to said side window and forms a waterproof joint with the side window of the base body.

17. The assembly according to claim 10, wherein the superstructure is only in pressing contact with the base body in each of a left-hand and right-hand side portion.

18. The assembly according to claim 10, wherein the base body includes a trunk having a trunk seal, and the superstructure forms a waterproof joint in pressing contact with the trunk seal.

19. The assembly according to claim 10, wherein the base body forms a notchback which the superstructure spans.

20. The assembly according to claim 19, wherein the trunk comprises a lock or a bolt, and the superstructure includes a hinged hatchback which is engagable with the lock or bolt.

21. The assembly according to claim 10, wherein the base body includes an open trunk, and the superstructure spans the and encloses the open trunk.

22. The assembly according to claim 21, wherein the trunk comprises a lock or a bolt, and the superstructure includes a hinged hatchback which is in engagable with the lock or bolt.

23. The body according to claim 10, wherein a convertible roof configured to be manually or automatically extended and retracted is assembled and retracted on the base body.

24. A superstructure system for assembling on a body of a motor vehicle which comprises a passenger compartment, said superstructure assembly comprising:
a first superstructure forming a solid roof configured to extend beyond the passenger compartment as far as a rear end of the body; and
a second superstructure including a convertible roof;
wherein the first and second superstructures are configured such that the convertible roof of the second superstructure must be disassembled from the body or retracted relative to the body prior to assembly of the first superstructure on the body.

25. The superstructure system according to claim 24, wherein the first and second superstructures comprise edges which are identical in their contours at their front ends and their two side portions following and connected to the front end, for a waterproof pressing contact with the body.

26. The superstructure system according to claim 24, wherein the body comprises at least one connecting element, and each of the first and second superstructures comprises at least one engaging element configured for a releasable fastening engagement with the connecting element.

27. The superstructure system according to claim 26, wherein the engaging elements of the first and second superstructures are identical.

28. The superstructure system according to claim 29, wherein the body includes a trunk which can be closed by means of a trunk lid forming part of the second superstructure, and wherein the first superstructure is configured to be assembled on the body, spanning the trunk, when the trunk lid has been disassembled.

29. The superstructure system according to claim 28, wherein the trunk comprises a lock or bolt, and the first superstructure and the trunk lid of the second superstructure each include an engaging means for engaging with the lock or bolt.

30. A production assembly for assembling bodies of motor vehicles, each comprising at least one of the first or second superstructures according to claim 23, said production assembly including:
a) a conveying line for transporting groups of body parts, at least one body part for each of the bodies;
b) one or more working stations arranged along the conveying line, for joining and permanently fixedly connecting the body parts of each group to form a respective body comprising a passenger compartment which is open upwards in each case;
c) a first assembly station, downstream of the one or more working stations along the conveying line, configured to assemble one of the first superstructures on one of the bodies;
d) and a second assembly station, downstream of the one or more working stations, configured to assemble one of the second superstructures on one of the bodies.

31. The production assembly according to claim 30, wherein the second assembly station is arranged downstream of the first assembly station along the conveying line, for assembling both types of superstructures in-line, or is arranged in a branch of the conveying line, parallel to the first assembly station.

32. The production assembly according to claim 30, wherein the second assembly station is arranged downstream of the conveying line, for assembling the second superstructures off-line.

33. The production assembly according to claim 32, further comprising a storage facility for the interim storage of bodies prior to assembly with a superstructure.

34. The production assembly according to claim 30, further comprising a controller configured to activate the first assembly station for assembling the a first superstructure to one of the bodies and to deactivate the first assembly station for conveying bodies intended for assembly with a second superstructure through.

35. The production assembly according to claim 30, wherein at least one of the assembly stations is arranged along the conveying line downstream of a painting station for painting the respective body.

36. The production assembly according to claim 30, wherein at least one of the assembly stations is arranged along the conveying line downstream of a third assembly station for assembling seats or a dashboard or a steering wheel or a side door of the vehicle.
